(19) United States
(12) Patent Application Publication
(10) Pub. No.: US 2024/0086687 A1
(43) Pub. Date: Mar. 14, 2024

(54) DEEP LEARNING MODELING WITH DATA DISCONTINUITIES

(71) Applicant: THE BANK OF NEW YORK MELLON, New York, NY (US)

(72) Inventor: Philipp RIEDER, New York, NY (US)

(21) Appl. No.: 17/940,126

(22) Filed: Sep. 8, 2022

(51) Int. Cl. G06N 3/04

(52) U.S. Cl. CPC G06N 3/0481

(57) ABSTRACT

The disclosure relates to systems and methods of deep learning with data discontinuities. A discontinuity may refer to a concatenation point in a series of data, such as a time series data, at which two sequences of data have been joined. A system may address data discontinuities by tuning a model parameter that minimizes error around concatenation points. For example, the model parameter may include a sample weight that is applied to data values adjacent to the concatenation points. A sample weight may be specifically tuned based on one or more characteristics of the input data. The characteristics may include a frequency of concatenation points relative to the length of a concatenated time series, a magnitude of the discontinuity, and/or other characteristics of the input data having discontinuities. In this manner, optimizers for deep learning penalize error resulting from the discontinuities, which may reduce overall modeling error.

### CROSS-REFERENCE TO RELATED APPLICATIONS

This application is related to co-pending U.S. patent application Ser. No. ______, filed on ______, Attorney Docket No. 201818-0571144, entitled “Mapping activation functions to data for deep learning,” which is incorporated by reference in its entirety herein for all purposes.

### BACKGROUND

Deep learning models such as neural networks may require sufficient data for training. Oftentimes the data exhibits certain properties that cause modeling errors. Data sparsity may also cause modeling errors. For example, oftentimes time series data needs to be sufficiently long to be able to make useful predictions. In some data sparse environments, data may be concatenated together to form longer stretches of data for machine learning. However, concatenated data may result in discontinuities that may lead to modeling errors. These and other issues may exist in deep learning systems.

### SUMMARY

Various systems and methods may address the foregoing and other problems. For example, a system may address modeling error caused by certain properties of data by mapping deep learning activation functions to the input data. An activation function may generate an output of a neuron based on the output of another neuron at a prior layer of a neural network in a process referred to as feed forward propagation. In some examples, the neural network may include a recurrent neural network, in which case the activation function may generate an output of a neuron based on the output of another neuron at a prior layer of a neural network and retained memory (or output) of the neuron from a previous timestep. The system may select one or more activation functions for one or more layers of a neural network based on properties that cause modeling errors or otherwise should be accounted for. The properties that may cause modeling error or otherwise should be accounted for in deep learning may include skewness, kurtosis, range boundedness, and/or other properties.

A selected activation function may be placed at one or more layers of the neural network for feed-forward propagation through neurons (nodes) of the layer. For example, the activation function may be placed at a hidden layer and/or an output layer. At least some of these layers may include a fully connected dense layer of the neural network. In some examples, the selected one or more activation functions may include two or more distinct activation functions. In these examples, a first activation function may be placed at a first layer of the neural network and the second activation function may be placed at a second layer of the neural network. In some of these examples, the first layer and the second layer may be adjacent to one another. In this manner, the neural network may be tuned with specific activation functions that align with the properties of the input data.

A system may address data discontinuities by tuning a model parameter that minimizes error around the concatenation points. For example, the model parameter may include a sample weight that is applied to data observations (samples) coinciding with concatenation points. A sample weight may be specifically tuned based on one or more characteristics of the input data. The characteristics may include a frequency of concatenation points relative to the length of a concatenated time series, a magnitude of the discontinuity, and/or other characteristics of the input data having discontinuities. In this manner, optimizers for deep learning may be forced to penalize error resulting from the discontinuities at a higher rate, thereby reducing the overall modeling error.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system of mapping activation functions to input data for deep learning and/or deep learning with data discontinuities;

FIG. 2A illustrates a schematic example of a neural network with activation functions, one or more of which may be mapped to the input data;

FIG. 2B illustrates a schematic example of a neural network implemented as a recurrent neural network (RNN);

FIG. 3 illustrates examples of selection criteria for mapping activation functions to the input data;

FIG. 4 illustrates an example of a method of mapping activation functions to the input data for deep learning models;

FIG. 5 illustrates an example of a method of mapping multiple activation functions each at a respective layer of a neural network to the input data;

FIG. 6 illustrates an example of a method of training a neural network with an activation function selected based on the input data;

FIG. 7 illustrates a plot of an example of input data to which activation functions may be mapped to account for properties of the input data;

FIG. 8 illustrates a plot of another example of input data to which activation functions may be mapped;

FIG. 9 illustrates an example of a method of deep learning modeling with data discontinuities;

FIG. 10 illustrates an example of another method of deep learning modeling with data discontinuities.

FIG. 11 illustrates a plot of an example of input data having data discontinuities; and

FIG. 12 illustrates a plot of another example of input data having data discontinuities.

### DETAILED DESCRIPTION

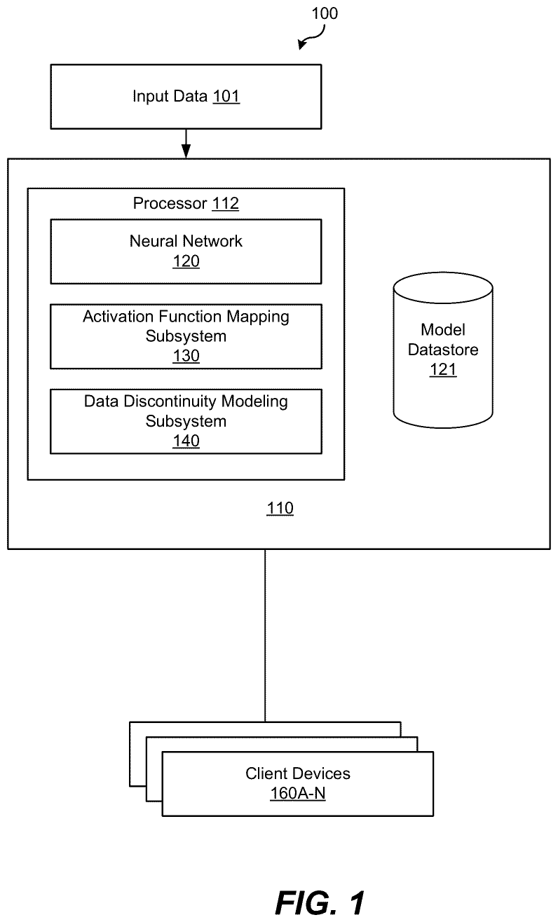

The disclosure relates to systems and methods of mapping deep learning activation functions to data and/or modeling data discontinuities. One or more properties of input data may make it difficult or otherwise should be accounted for in deep learning systems. These properties may include skewness, kurtosis, range boundedness, and/or other behaviors. A system may address these and other issues by mapping deep learning activation functions to input data. Examples of mapping deep learning activation functions to input data and related features are described with respect to FIGS. 1 through 8.

Another issue that makes deep learning from the input data difficult is when the input data includes discontinuities. A discontinuity may refer to a concatenation point in a series of data, such as time series data, at which two sequences of data have been joined. For example, two time series data may be concatenated together to form a synthetic time series data that includes a discontinuity where they were concatenated. Two or more sequences of data may be joined for various reasons, such as to join unrelated but similar data values for learning, assemble multiple time series data taken at different time points, increase the amount of historical data from which to learn in sparse data contexts, and/or other reasons. In some examples, from an end of day data perspective (or other increment of time series data), a new observation that is different from a prior day observation represents a “discontinuity.” Mathematically, a function is non-differentiable if it is discontinuous (leading to infinite derivatives). In the context of empirical time series, a discontinuity may mark a relatively large jump that is inconsistent with prior data patterns and is hard to model or predict. Discontinuities exhibiting such “jump” may result in modeling error.

Modeling data having discontinuities may be difficult because machine-learning models may learn from the concatenated data with the assumption that the data represents a single continuous time series. In reality, however, the concatenated data may include time series from multiple data sets and/or from different time periods that may not necessarily reflect a continuous timeline. In particular, modeling data having discontinuities, such as conducting deep learning from the data, may result in underfitting or overfitting depending on the learning approach taken. If the data having discontinuities is smoothed using a smoothing algorithm in an attempt to account for changes in the data at a concatenation point, then overfitting may result by learning from smoothed data that is not representative of the actual data. On the other hand, simple concatenation of the data without smoothing may result in underfitting distinct features adjacent to the concatenation points. A system may address these and other issues by tuning a model parameter that minimizes error around the concatenation points. Examples of modeling data discontinuities and related features are described with respect to FIGS. 1 and 9-12.

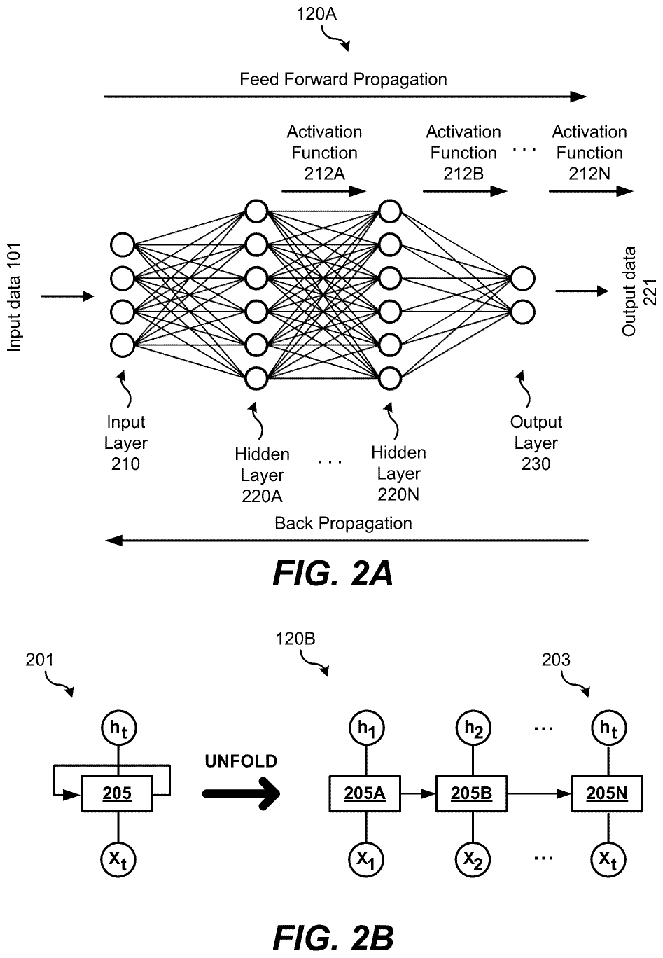

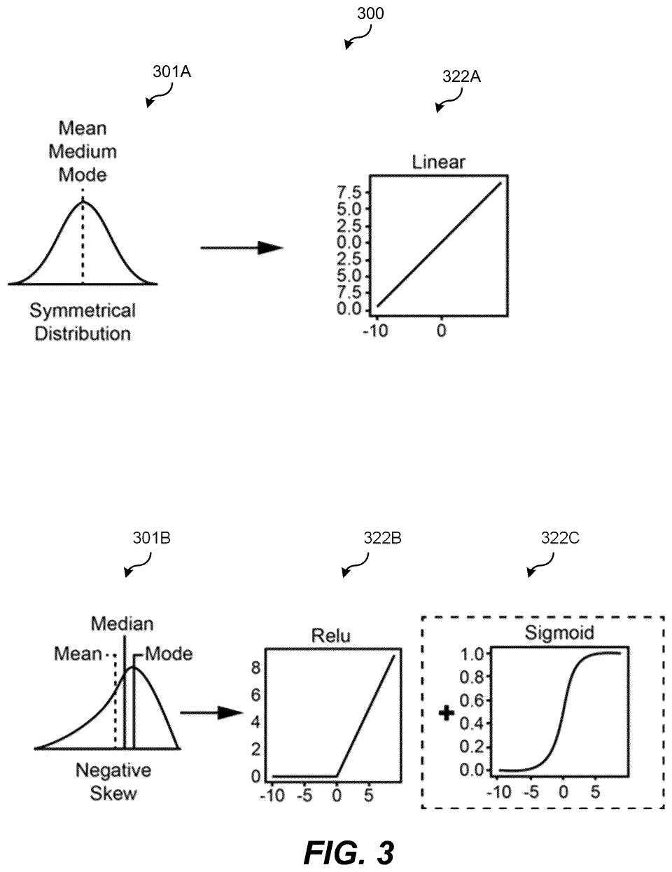

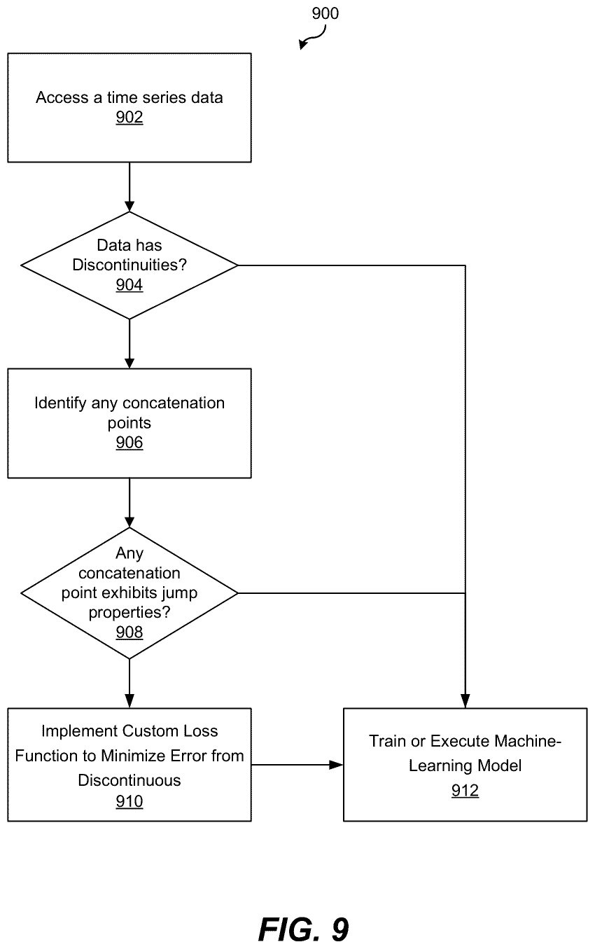

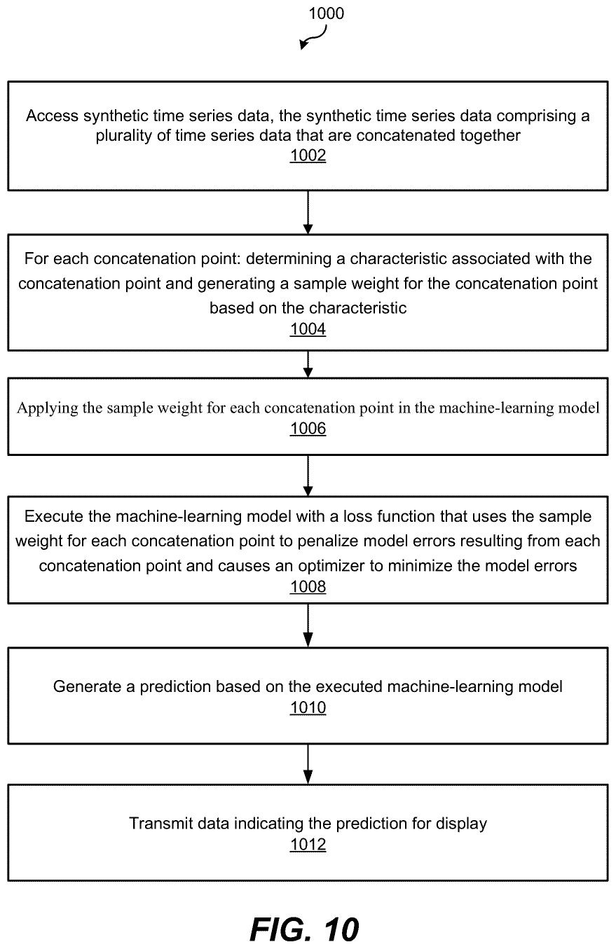

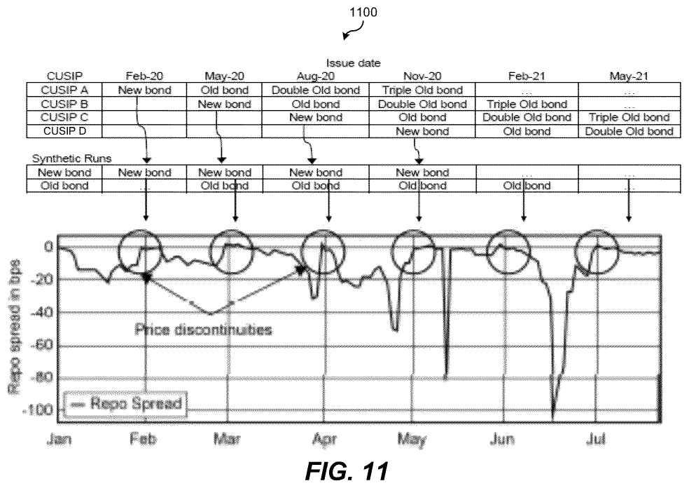

FIG. 1 illustrates an example of a system 100 of mapping activation functions to input data 101 for deep learning and/or deep learning with data discontinuities. The system 100 may include a computer system 110, one or more client devices 160 (illustrated as client devices 160A-N), and/or other components. The input data 101 may include a plurality of data values that are modeled for prediction by the computer system 110. The input data 101 may include various types of values depending on the context in which the system 100 operates. Examples of the input data 101 are illustrated in FIGS. 2, 3, 9, and 10. Reference to FIGS. 2 and 3 (as well as FIGS. 1 and 4-8) will be made when describing examples of mapping the input data 101 to activation functions. Reference to FIGS. 9 and 10 (as well as FIGS. 1 and 11) will be made when describing examples of modeling data discontinuities.

To address the foregoing issues with deep learning frameworks, the computer system 110 may include one or more processors 112, a model datastore 121, and/or other components. The processor 112 may include one or more of a digital processor, an analog processor, a digital circuit designed to process information, an analog circuit designed to process information, a state machine, and/or other mechanisms for electronically processing information. Although processor 112 is shown in FIG. 1 as a single entity, this is for illustrative purposes only. In some embodiments, processor 112 may comprise a plurality of processing units. These processing units may be physically located within the same device, or processor 112 may represent processing functionality of a plurality of devices operating in coordination.

As shown in FIG. 1, processor 112 is programmed to execute one or more computer program components. The computer program components may include software programs and/or algorithms coded and/or otherwise embedded in processor 112, for example. The one or more computer program components or features may include a neural network 120, an activation function mapping subsystem 130, a data discontinuity modeling subsystem 140, and/or other components or functionality.

Processor 112 may be configured to execute or implement 120, 130, and 140 by software; hardware; firmware; some combination of software, hardware, and/or firmware; and/or other mechanisms for configuring processing capabilities on processor 112. It should be appreciated that although 120, 130, and 140 are illustrated in FIG. 1 as being co-located in the computer system 110, one or more of the components or features 120, 130, and 140 may be located remotely from the other components or features. The description of the functionality provided by the different components or features 120, 130, and 140 described below is for illustrative purposes, and is not intended to be limiting, as any of the components or features 120, 130, and 140 may provide more or less functionality than is described, which is not to imply that other descriptions are limiting. For example, one or more of the components or features 120, 130, and 140 may be eliminated, and some or all of its functionality may be provided by others of the components or features 120, 130, and 140, again which is not to imply that other descriptions are limiting. As another example, processor 112 may include one or more additional components that may perform some or all of the functionality attributed below to one of the components or features 120, 130, and 140.

Deep Learning Based on Activation Function Mapping and/or Data Discontinuities

The neural network 120 includes a computational learning system that uses a network of neurons to translate input data of one form into a desired output. A neuron may refer to an electronic processing node implemented as a computer function, such as one or more computations. An example of the neural network 120 will be described with reference to FIGS. 2A and 2B. FIG. 2A illustrates a schematic example of a neural network 120A with one or more activation functions 212 (illustrated as activation functions 212A-N), one or more of which may be mapped to the input data 101. In FIG. 2, neurons are represented as circles with lines representing connections to other neurons.

The neural network 120A may include an input layer 210 that accepts input data 101, one or more hidden layers 220 (illustrated as hidden layers 220A, N), and a fully connected output layer 230 (also referred to as “output layer 230” for convenience) that generates output data 221, which may include a prediction relating to the input data 101. Although only two hidden layers 220 are shown, other numbers of hidden layers 220 may be used depending on the complexity of the neural network 120A that is used. Furthermore, the number of neurons in each of the layers 210, 220, and 230 are shown for illustration. Other numbers of neurons at each layer may be used. In some examples, at least some of the hidden layers 220 and/or the output layer 230 may be considered a “dense layer.” A dense layer is one in which neurons at that layer receives the output of all neurons of a previous layer. As such, a neuron at a dense layer may be referred to as “fully connected.”

Each hidden layer 220 may include one or more neurons. Each neuron in each of the hidden layers 220 and the output layer 230 may receive (as input) the output of a neuron of a prior layer. The neuron may then apply an activation function 212 (illustrated as activation functions 212A-N) to the input data, which is an output of the neuron of the prior layer. The activation function 212 may in turn generate its output based on the input data. This process may continue through to the fully connected output layer 230 in a process referred to as “Feed Forward Propagation.” In some examples, an activation function 212 (illustrated as activation function 212N) is applied even at the fully connected output layer 230 to generate the output data 221. Other numbers of activation functions 212 may be included, depending on the number of layers.

The activation function determines what is fed forward in the neural network 120A to the next neuron (or hidden cell). In other words, an activation function may generate an output at a given neuron based on the output of another neuron at a prior layer of the neural network 120A. A prediction is then made based on which an error metric is calculated. Based on this, weights are updated in what is called back propagation. An example of an activation function, Activation( ), may be given by Equation 1:

Y=Activation(Σ(Weights*Inputs)+Bias) (1),

in which Weights are learned and updated, Bias is a parameter that shifts the activation function 212, and Y is the output of a given neuron, which may be fed forward or is an output of the neural network 120.

In some examples, during back propagation the Weights may be updated based on an error rate observed from a prior epoch as compared to known outcomes in historical data used for training. During the process of backpropagation, the neural network 120A is therefore fine-tuned to learn from the training data. The training process may be iterated N epochs, where N may be a hyperparameter input to the model.

It should be noted that the neural network 120A may include different types of neural networks, such as be implemented using various models, such as a feed forward neural network, a perceptron, a multilayer perceptron, a convolution neural network (CNN), a recurrent neural network (RNN), a Long Short Term Memory (LSTM), and/or other types of neural networks that may use activation functions.

For example, FIG. 2B illustrates a schematic example of a neural network 120B implemented as an RNN. The neural network 120B may include activation functions 212A,N (not illustrated in FIG. 2B for brevity) similar to the activation functions 212A,N illustrated in FIG. 2A. For example, an activation function 212 may be selected for a given neuron of a given layer in the RNN based on one or more properties of the input data 101. Referring to FIG. 2B, 201 shows a schematic of the RNN and 203 an unfolded schematic of the RNN showing individual timesteps in a sequence of the input data 101. 205A-N represents the hidden states, or memory, of the neural network 120B at a given timestep (t). Thus, 205A-N may represent a state of neurons in the neural network 120B at timestep (t). Xₜ and hₜ respectively represent inputs to and outputs of the neural network 120B at timestep (t). For example, Xₜ is taken as the input to the neural network 120B for timestep (t), which generates hₜ as output for timestep (t). As would be appreciated, each neuron in the neural network 120B may have its own respective state at timestep (t). Accordingly, each neuron in the neural network 120B will receive its input Xₜ and generate its output hₜ.

Referring to 203, at timestep t=1, the hidden state 205A (which collectively refers to memory of neurons at timestep t=1) may receive an input X₁. The input X₁ may include a data value from the input data 101 at timestep t=1. The hidden state 205 may generate an output h₁. At timestep t=2, the hidden state 205B may receive an input X₂. The input X₂ may include a data value from the input data 101 at timestep t=2. The hidden state 205B may also receive (or retain) the previous hidden state 205A and generate an output h₂. This process may repeat for each timestep (t) in the input data 101. Thus, in neural network 120B, a given neuron may receive the output of a prior layer's neurons of a current timestep (t) and retain or receive its own output from a prior timestep (t-1) to generate its output for the current timestep.

Activation Function Mapping

The activation function mapping subsystem 130 may map one or more activation functions 212 of the neural network 120 to the input data 101. An activation function 212 may also be referred to as a “deep learning activation function.” The activation function mapping subsystem 130 may select one or more activation functions 212 based on one or more properties of the input data 101. In this manner, the neural network 120 may be trained and fine-tuned in a way that aligns with the input data 101. The activation function may be selected from among a Rectified Linear Unit (ReLU), sigmoid function, linear function, hyperbolic tangent (tanh), Heaviside, Gaussian, SoftMax function and/or other types of activation functions. The one or more properties may include skewness, kurtosis (such as Leptokurtic), range boundedness, and/or other properties.

The selected one or more activation functions 212 may be implemented at one or more layers of the neural network 120. For example, after selection of the one or more activation functions 212, the activation functions may be implemented at one or more neurons of one or more hidden layers 220A-N and/or one or more neurons of the output layer 230. In some examples, a selected activation function is placed at least at the output layer 230. In some examples, more than one activation function may be selected and placed at respective layers. In some of these examples, two or more selected activation functions may be different activation functions. In some examples, at least two activation functions are placed at adjacent layers of the neural network 120. In some of these examples, one of the selected activation functions is placed at a fully connected output layer of the neural network 120 and another one of the selected activation functions is placed at the layer adjacent to the fully connected output layer of the neural network 120.

The neural network 120 may be trained using historical data. The historical data may include prior data used for making predictions based on the input data 101. For example, if the input data 101 includes repo spread data as illustrated in FIG. 11, historical repo spreads may be used to train the neural network 120 to predict future repo spreads.

FIG. 3 illustrates examples of selection criteria for mapping activation functions to the input data 101. The activation function mapping subsystem 130 may use the selection criteria to select one or more activation functions based on (to fit) the input data 101. For example, the activation function mapping subsystem 130 may analyze data distribution properties, including skewness, kurtosis and range boundedness. Based on the disclosures herein, dense layer activation functions should align with the data distribution of the input data 101. The activation function mapping subsystem 130 may define thresholds based on which deep learning activation functions are mapped to the data. For example, any skewness in the data that is different from a normal distribution should be modeled via ReLU activation function. Activation functions that are consistent with distributional properties ensure that a) outputs are fed forward in a way that preserves distributional properties of the target and b) outputs are constrained within the interval of the target. We set skewness thresholds to the range [−0.5,0.5]. For data with skewness values outside of that range we recommend using a ReLU activation function.

For example, plot 301A illustrates an example of a symmetrical distribution of input data 101. For symmetrical distributions, the activation function mapping subsystem 130 may select a linear activation function represented by the plot 322A.

In another example, plot 301B illustrates an example of a skewed distribution of input data 101. For skewed distributions, the activation function mapping subsystem 130 may select a ReLU activation function represented by the plot 322B. In some examples, the activation function mapping subsystem 130 may also select a sigmoid activation function represented by the plot 322C. For example, the activation function mapping subsystem 130 select the sigmoid activation function if the input data 101 is rangebound or quasi-rangebound.

An advantage of using the ReLU function over other activation functions is that it does not activate all the neurons at the same time. This means that the neurons will only be deactivated if the output of the linear transformation is less than 0. Unlike binary step and linear functions, Sigmoid is a non-linear function. This essentially means the output is non-linear as well. The tanh function is similar to the sigmoid function, except that tanh is symmetric around the origin. The range of values in this case is from −1 to 1. Thus, the inputs to the next layers will not always be of the same sign.

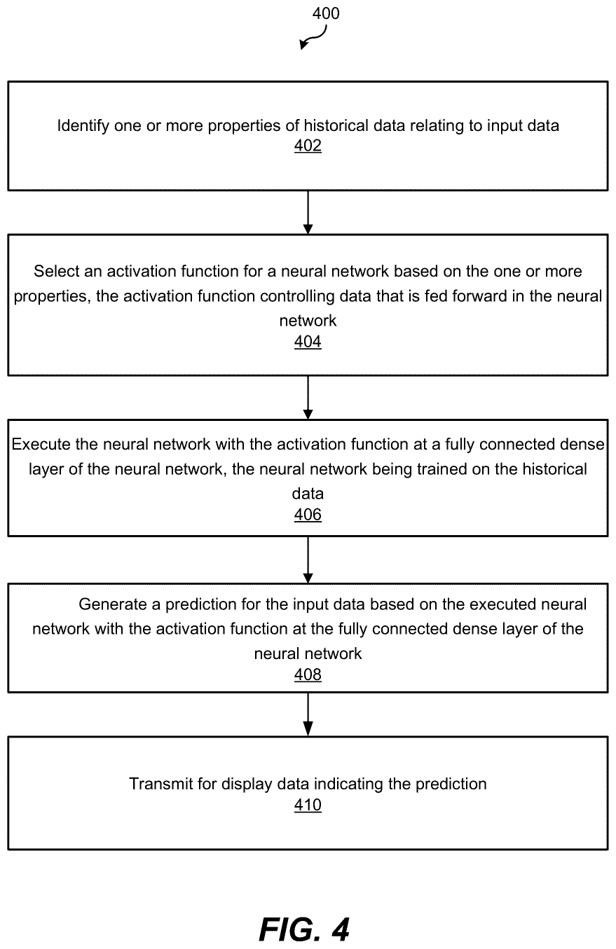

FIG. 4 illustrates an example of a method 400 of mapping activation functions (such as activation functions 212A-N) to the input data for deep learning models. At 402, the method 400 may include identifying one or more properties of historical data relating to input data (such as input data 101). At 404, the method 400 may include selecting an activation function for a neural network (such as neural network 120) based on the one or more properties, the activation function controlling data that is fed forward in the neural network. In some examples, the activation function is selected based on one or more selection criteria illustrated in FIG. 3 to ensure that outputs of nodes (such as neurons of a layer) in the neural network are fed forward in a way that preserves the one or more properties of the input data and to ensure that outputs of the nodes are constrained within the interval of the input data.

At 406, the method 400 may include executing the neural network with the activation function at a fully connected dense layer (such as output layer 230 and/or other dense layer) of the neural network, the neural network being trained on the historical data. At 408, the method 400 may include generating a prediction for the time series in the input data based on the executed neural network with the activation function at the fully connected dense layer of the neural network. The particular prediction made will vary based on the input data. For example, if the input data is repo spread data, the prediction may include a prediction of a future repo spread. If the input data includes weather data, the prediction may include a prediction of a future weather condition. Other types of input data may be modeled and predicted based on deep learning activation function mapping as well. At 410, the method 400 may include transmitting for display data indicating the prediction. The data may include the next predicted value in the input data 101, a graphic such as a chart of the predicted data, and/or other information for display.

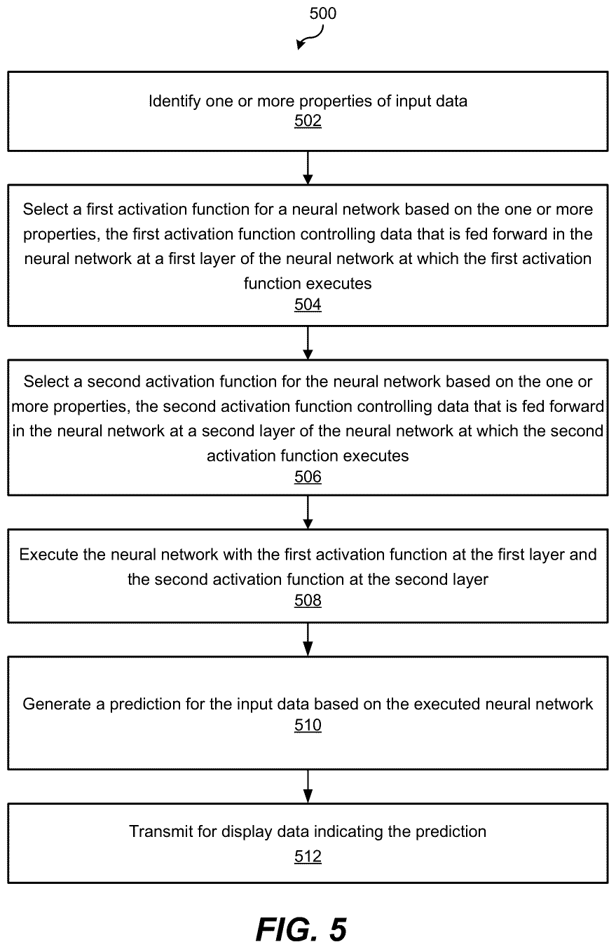

FIG. 5 illustrates an example of a method 500 of mapping multiple activation functions (such as activation functions 212A-N illustrated in FIG. 2) each at a respective layer of a neural network to the input data 101. At 502, the method 500 may include identifying one or more properties of input data. At 504, the method 500 may include selecting a first activation function for a neural network based on the one or more properties, the first activation function controlling data that is fed forward in the neural network at a first layer of the neural network at which the first activation function executes. At 506, the method 500 may include selecting a second activation function for the neural network based on the one or more properties, the second activation function controlling data that is fed forward in the neural network at a second layer of the neural network at which the second activation function executes. At 508, the method 500 may include executing the neural network with the first activation function at the first layer and the second activation function at the second layer. At 510, the method 500 may include generating a prediction for the time series of value in the input data based on the executed neural network. At 512, the method 500 may include transmitting for display data indicating the prediction.

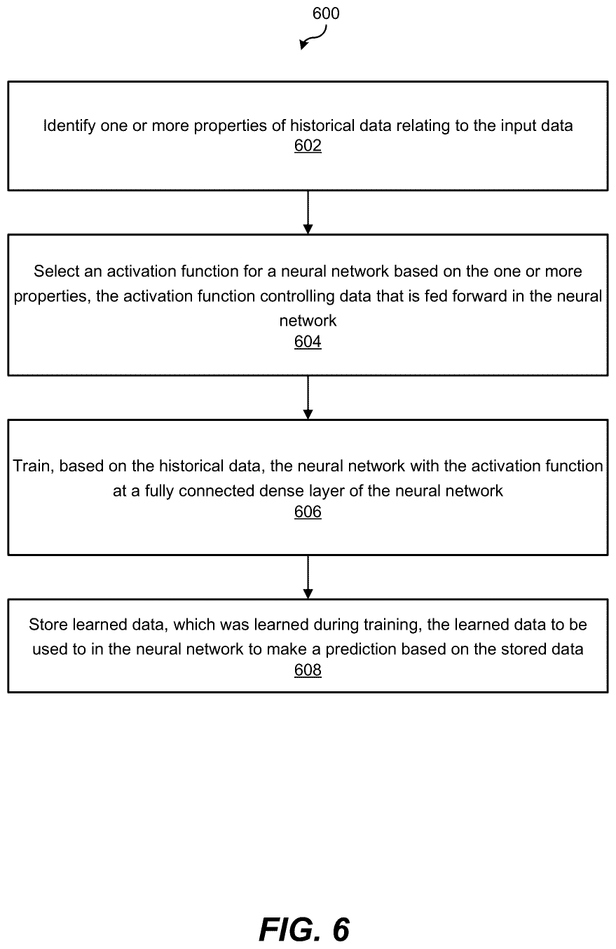

FIG. 6 illustrates an example of a method 600 of training a neural network with an activation function selected based on the input data 101. At 602, the method 600 may include identifying one or more properties of historical data relating to the input data. At 604, the method 600 may include selecting an activation function for a neural network based on the one or more properties, the activation function controlling data that is fed forward in the neural network.

At 606, the method 600 may include training, based on the historical data, the neural network with the activation function at a fully connected dense layer of the neural network. At 608, the method 600 may include storing (such as in model datastore 121) learned data, which was learned during training, the learned data to be used to in the neural network to make a prediction based on the stored data. The stored learned data may include the Weights learned and/or updated in the neural network. In some examples, the stored learned data may be stored in association with model conditions used for training.

Examples of Input Data for which Activation Function Mapping May be Performed

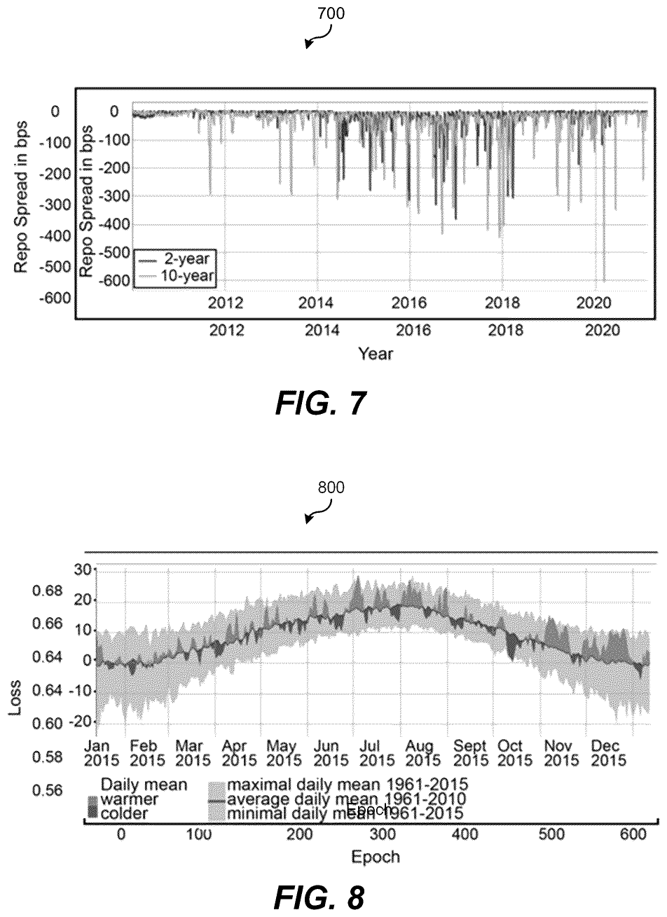

For example, FIG. 7 illustrates a plot 700 of an example of input data 101 to which activation functions may be mapped. The plot 700 shows a time series of Repo Spread Indicator (RSI) values plotted in basis points (bps). RSI helps identify Treasury securities expected to trade ‘special’. A bond is said to trade special when it trades at a price premium in bilateral repo due to high demand. This excess demand is driven by short demand by dealers and other long/short accounts like hedge funds in order to make markets, hedge rates risk or outright short positions.

Repo spreads are a key driver of funding cost for dealers and hedge funds. Historically spreads have exhibited volatility of several hundred basis points during Treasury security auction cycles. Repo spreads are highly asymmetric, hovering close to zero (but negative) most of the time, and widening significantly to more negative values during times of scarcity as shown in FIG. 7. Spreads are also quasi-range bound between zero and the Treasury Market Practices Group (TMPG) charge, equating to a level of −300 bps during a low interest rate environment. These and other properties may make deep learning difficult from time series of RSI values.

FIG. 8 illustrates a plot 800 of another example of input data 101 to which activation functions may be mapped. Plot 800 shows weather data, which typically fluctuates within historical bands, including temperatures, air pressure or humidity. Understanding the data structure and behavior enables the selection of a deep learning model architecture that matches data patterns. For example, if the neural network 120 were trained to predict the average temperature, it is likely that a fully connected dense layer with a sigmoid activation function outperforms other activation functions.

On the other hand, if the neural network 120 were trained to predict excess temperatures over seasonal averages, this would likely be an asymmetric target to predict, as the weather becomes more volatile towards to upside. In this example, a ReLU dense layer may be selected to be added to the sigmoid activation function or used instead of the sigmoid activation function.

Modeling Data Discontinuities

Modeling data having discontinuities may be difficult because machine-learning models may learn from the concatenated data with the assumption that the data represents a single continuous time series. In particular, modeling data having discontinuities, such as conducting deep learning from the data, may result in underfitting or overfitting depending on the learning approach taken. If the data having discontinuities is smoothed using a smoothing algorithm in an attempt to account for changes in the data at a concatenation point, then overfitting may result by learning from smoothed data that is not representative of the actual data. On the other hand, simple concatenation of the data without smoothing may result in underfitting distinct features adjacent to the concatenation points.

To address these and other issues, the data discontinuity modeling subsystem 140 (illustrated in FIG. 1) may model data discontinuities in the input data 101. For example, the data discontinuity modeling subsystem 140 may address issues introduced by discontinuities in the input data 101 by tuning a model parameter that minimizes error around one or more concatenation points. For example, the model parameter may include a sample weight that is applied to data values adjacent to the concatenation points. A sample weight may be specifically tuned based on one or more characteristics of the input data 101. The characteristics may include a frequency of concatenation points relative to the length of a concatenated time series, a magnitude of the discontinuity, and/or other characteristics of the input data 101 having discontinuities.

The data discontinuity modeling subsystem 140 may identify input data 101 having discontinuities. For example, the input data 101 may include a synthetic time series, which refers to sequential data that is composed of multiple, concatenated time series. Synthetic times series may be generated to facilitate modeling over longer time periods.

The data discontinuity modeling subsystem 140 may identify concatenation points in the input data 101. The concatenation points are positions in the input data 101 where the multiple component time series have been joined. The data discontinuity modeling subsystem 140 may determine whether a concatenation point exhibits certain behaviors that would make subsequent modeling activity more difficult, since machine learning models will generally attempt to perform smoothing at concatenation points. The behaviors may include “jump” behavior described with respect to the example of input data illustrated in FIG. 11.

The data discontinuity modeling subsystem 140 may assign sample weights that are larger for concatenation points exhibiting jump or other behavior than other positions in the input data 101. In this way, during model training, the optimizer may minimize errors at these concatenation points. For example, a larger sample weight at the concatenation point may force the model optimizer to keep prediction errors small, minimizing any “smoothing” effects.

The data discontinuity modeling subsystem 140 may select sample weights based on various sample weight criteria. The sample weight criteria may include the frequency of concatenation points relative to the length of the individual concatenated time series (where larger sample weights are assigned for higher frequencies), the magnitude of the concatenation data discontinuity (where larger sample weights may be assigned for larger magnitudes), and/or other criteria. For some types of input data 101, different sample weights may be assigned to different concatenation points. For example, for RSI data, not each Treasury security auction has the same spread patterns. As such, different sample weights may be assigned for different concatenation points between auctions. In particular, the data discontinuity modeling subsystem 140 may assign a first sample weight to a first concatenation point between a first pair of auctions that were joined and a second sample weight to a second concatenation point between a second pair of auctions that were joined. For example, a first sample weight (such as 2) may be applied for month ends while a second sample weight (such as 3) may be applied for month ends that are also year ends in a Treasury security auction.

In some examples, the data discontinuity modeling subsystem 140 may generate and implement a custom loss function (CLF) to penalize model errors. A loss function assesses loss, or error, with model outputs against known, expected, values. Different types of loss functions may be used such as a mean squared error, a likelihood loss function, a log loss function, and/or other operations that assesses error in model outputs. With the CLF, the data discontinuity modeling subsystem 140 causes the machine-learning model to work harder to obtain good fits around the concatenation points.

The CLF may be implemented via sample weights for each of the concatenation points (such as Treasury security new issue dates illustrated in FIG. 11) and any non-concatenation points so that different weights may be accounted for in the CLF across the time series. In the following example, concatenation points are assigned with a weight of 1.5 while others get a weight of 1, as shown in the following example of a weight tensor:

```
<tf.Tensor: shape=(8, 5, 1), dtype=float32, numpy=
Array([[[1. ],
  [1.5],
  [1. ],
  [1. ],
  [1. ]],
```

The sample weights may be configured and input to the machine-learning model as a hyperparameter. In some examples, a default sample weight of 1.0 for portions of the synthetic time series observations (samples) that are not concatenated. In some of these examples, the sample weight is substantially 1.5 for concatenated points for which smoothing would introduce errors, such as concatenated points that exhibit jump behavior. In some of these examples, the sample weight is selected from the range including substantially 1.5-5.0 for concatenated points for which smoothing would introduce errors, such as concatenated points that exhibit jump behavior. The term “substantially” in this context may refer to +/−ten percent, twenty percent, or thirty percent.

FIG. 9 illustrates an example of a method 900 of deep learning modeling with data discontinuities. At 902, the method 900 may include accessing a time series data (such as the input data 101). At 904, the method 900 may include determining whether the time series data has discontinuities. For example, certain types of data such as synthetic time series data for multiple auctions (an example of which is illustrated in FIG. 11) will include discontinuities. Such data may be known to have discontinuities whereas other time series data may not. If the time series data does not have discontinuities, at 912, the method 900 may proceed to training or executing a machine-learning model. The machine-learning model may include the neural network 120 and/or other machine-learning models that may model time series data.

Returning to 904, if the time series data includes a discontinuity, at 906, the method 900 may include identifying one or more concatenation points. At 908, the method 900 may include determining whether any of the concatenation points exhibits jump (or other) properties that cause modeling errors. If not, then the method 900 may proceed to 912. If so, then at 910, the method 900 may implement a custom loss function to minimize modeling errors from the discontinuities. For example, the custom loss function may be implemented using sample weights provided as a hyperparameter input to the machine-learning model. The method 900 may then proceed to 912.

FIG. 10 illustrates an example of another method 1000 of deep learning modeling with data discontinuities. At 1002, the method 1000 may include accessing synthetic time series data, the synthetic time series data comprising a plurality of time series data that are concatenated together. Each pair of concatenated time series data, from among the plurality of time series data, are joined together to form a respective concatenation point in the synthetic time series data.

At 1004, the method 1000 may include, for each concatenation point: determining a characteristic associated with the concatenation point and generating a sample weight for the concatenation point based on the characteristic. At 1006, the method 1000 may include applying the sample weight for each concatenation point in the machine-learning model.

At 1008, the method 1000 may include executing the machine-learning model with a loss function (such as the CLF) that uses the sample weight for each concatenation point to penalize model errors resulting from each concatenation point and causes an optimizer to minimize the model errors. At 1010, the method 1000 may include generating a prediction based on the executed machine-learning model. At 1012, the method 1000 may include transmitting data indicating the prediction for display.

Examples of Input Data having Data Discontinuities

FIG. 11 illustrates a plot 1100 of an example of input data having data discontinuities. In this example, different time series data for different bonds are concatenated based on maturity dates. The concatenation points may cause modeling errors due to the behavior of the data as a bond approaches its maturity date. For example, bonds become shorter in remaining lives over time as they move towards maturity. To create long time series for modeling purposes, synthetic securities may be generated, which are based on the concatenation of newly issued securities for a given auction over time.

Such synthetic securities introduce data discontinuities at the concatenation points (new issue dates) as pricing of risk at these two points on the yield curve (10 years and 9.75 years) is different. As the next security is traversed in the time series, duration risk is effectively increased by 0.25 years, and this extra risk commands an extra risk premium, thus causing jumps in the time series. Empirically, spreads on new issue dates typically collapse to near zero, as supply floods the market and excess demand is met (scarcity value vanishes). Because machine-learning models like the neural network 120 is inputted with a single time series (the synthetic security) and is unaware that there are different securities concatenated together in the synthetic security, such data discontinuities may be problematic to fit.

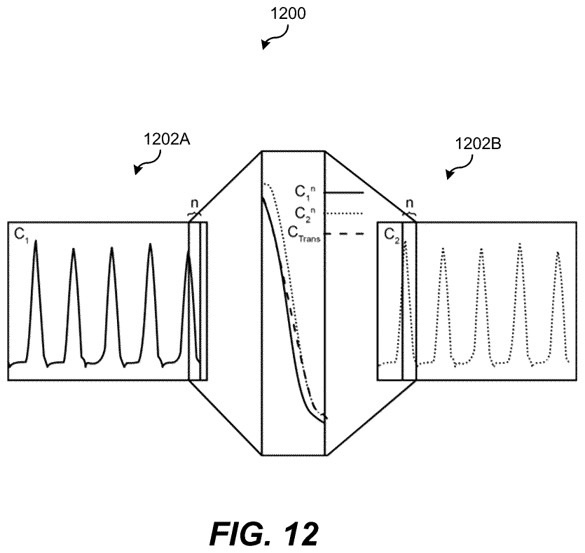

FIG. 12 illustrates a plot 1200 of another example of input data having data discontinuities. In this example, the plot 1200 shows a concatenation of a user's gait. Time series of collected gaits were cut into multiple shorter time series (1202A, 1202B) of varying lengths and subsequently concatenated. C-GAIT assessment scores (C₁ and C₂) are shown for each time series 1202A and 1202B. The concatenation point n may cause modeling errors for reasons described herein.

The computer system 110 and the one or more client devices 160 may be connected to one another via a communication network (not illustrated), such as the Internet or the Internet in combination with various other networks, like local area networks, cellular networks, or personal area networks, internal organizational networks, and/or other networks. It should be noted that the computer system 110 may transmit data, via the communication network, conveying the predictions one or more of the client devices 160. The data conveying the predictions may be a user interface generated for display at the one or more client devices 160, one or more messages transmitted to the one or more client devices 160, and/or other types of data for transmission. Although not shown, the one or more client devices 160 may each include one or more processors, such as processor 112.

Each of the computer system 110 and client devices 160 may also include memory in the form of electronic storage. The electronic storage may include non-transitory storage media (also referred to as medium) that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of modeling data discontinuities, comprising:
a processor programmed to:
access synthetic time series data, the synthetic time series data comprising a plurality of time series data that are concatenated together, wherein each pair of concatenated time series data, from among the plurality of time series data, are joined together at a respective concatenation point in the synthetic time series data;
for each concatenation point:
determine a characteristic associated with the concatenation point;
generate a sample weight for the concatenation point based on the characteristic;
apply the sample weight for each concatenation point in a machine-learning model;
execute the machine-learning model with a loss function that uses the sample weight for each concatenation point to penalize model errors resulting from each concatenation point and causes an optimizer to minimize the model errors;
generate a prediction based on the executed machine-learning model; and
transmit data indicating the prediction for display.

2. The system of claim 1, wherein the characteristic comprises a frequency of one or more concatenation points relative to a length a time series data from among the synthetic time series data.

3. The system of claim 1, wherein the characteristic comprises a magnitude of the data discontinuity.

4. The system of claim 1, wherein the processor is programmed to:
assign different sample weights to different concatenation points.

5. The system of claim 4, wherein the processor is further programmed to:
generate a first sample weight for a first concatenation point based on a first characteristic of the concatenation point; and
generate a second sample weight for a second concatenation point based on a second characteristic of the concatenation point, wherein the first sample weight and the second sample weight are different from one another.

6. The system of claim 1, wherein to generate the sample weight, the processor is further programmed to:
generate an array of the plurality of sample weights; and
input the array as a hyperparameter of the machine-learning model.

7. The system of claim 1, wherein the sample weight for each concatenation point is higher than other portions of the synthetic time series data.

8. A method of modeling data discontinuities, comprising:
accessing, by a processor, synthetic time series data, the synthetic time series data comprising a plurality of time series data that are concatenated together, wherein each pair of concatenated time series data, from among the plurality of time series data, are joined together at a respective concatenation point in the synthetic time series data;
for each concatenation point:
determining, by the processor, a characteristic associated with the concatenation point;
generating, by the processor, a sample weight for the concatenation point based on the characteristic;
applying, by the processor, the sample weight for each concatenation point in a machine-learning model;
executing, by the processor, the machine-learning model with a loss function that uses the sample weight for each concatenation point to penalize model errors resulting from each concatenation point and causes an optimizer to minimize the model errors;
generating, by the processor, a prediction based on the executed machine-learning model; and
transmitting, by the processor, data indicating the prediction for display.

9. The method of claim 8, wherein the characteristic comprises:
a frequency of one or more concatenation points relative to a length a time series data from among the synthetic time series data.

10. The method of claim 8, wherein the characteristic comprises:
a magnitude of the data discontinuity.

11. The method of claim 8, further comprising:
assigning different sample weights to different concatenation points.

12. The method of claim 11, further comprising:
generating a first sample weight for a first concatenation point based on a first characteristic of the concatenation point; and
generating a second sample weight for a second concatenation point based on a second characteristic of the concatenation point, wherein the first sample weight and the second sample weight are different from one another.

13. The method of claim 8, wherein generating the sample weight comprises:
generating an array of the plurality of sample weights; and
inputting the array as a hyperparameter of the machine-learning model.

14. The system of claim 1, wherein the sample weight for each concatenation point is higher than other portions of the synthetic time series data.

15. A non-transitory storage medium storing instructions that, when executed by a processor, programs the processor to:
access time series data having one or more discontinuities;
identify one or more concatenation points in the time series data;
determine that one or more concatenation points include a jump property;
implement a custom loss function (CLF) that uses a sample weight that is higher than a sample weight used for non-concatenation points in the time series data, the CLF causing a machine-learning model to minimize error from the one or more concatenation points that include the jump property; and
execute the machine-learning model.

16. The non-transitory storage medium of claim 15, wherein the instructions, when executed, further cause the processor to:
assign different sample weights to different concatenation points.

17. The non-transitory storage medium of claim 16, wherein the instructions, when executed, further cause the processor to:
generate a first sample weight for a first concatenation point based on a first characteristic of the concatenation point; and
generate a second sample weight for a second concatenation point based on a second characteristic of the concatenation point, wherein the first sample weight and the second sample weight are different from one another.

18. The non-transitory storage medium of claim 15, wherein the instructions, when executed, further cause the processor to:
input the sample weight as a hyperparameter of the machine-learning model.

19. The non-transitory storage medium of claim 15, wherein to generate the sample weight, instructions, when executed, further cause the processor to:
generate an array of a plurality of sample weights; and
input the array as a hyperparameter of the machine-learning model.

20. The non-transitory storage medium of claim 15, wherein the instructions, when executed, further cause the processor to:
generate the sample weight based on a characteristic associated with a concatenation point.
